(19) United States
(12) Patent Application Publication
(10) Pub. No.: US 2012/0281164 A1
(43) Pub. Date: Nov. 8, 2012

(54) LIGHT GUIDE PLATE POSITIONING STRUCTURE OF LIQUID CRYSTAL PANEL

(76) Inventors: I-Ting HUANG, Kaohsiung City (TW); Chi-Sheng Lin, Taoyuan County (TW)

(21) Appl. No.: 13/279,860

(22) Filed: Oct. 24, 2011

(30) Foreign Application Priority Data
May 6, 2011 (TW) 100208168

(51) Int. Cl. G02F 1/1335

(52) U.S. Cl. 349/62

(57) ABSTRACT

A light guide plate (LGP) positioning structure of a liquid crystal panel is provided. The liquid crystal panel includes a frame for a LGP to be placed in, and a light emitting module is disposed on the frame and is adjacent to the light guide plate, and has a plurality of light emitting units arranged with gaps. The LGP positioning structure includes a plurality of first, second positioning blocks, and positioning portions. Each first positioning block is disposed on the frame and is corresponds to a corner of the LGP. The positioning portions are formed at corners of the LGP and used to be held against the corresponding first positioning blocks. The second positioning blocks are disposed on the frame, located between the gaps, and used to resist a side edge of the LGP. A space is formed between the light emitting units and the LGP.

### CROSS-REFERENCE TO RELATED APPLICATION

This application claims the benefit of Taiwan Patent Application No. 100208168, filed on May 06, 2011, which is hereby incorporated by reference for all purposes as if fully set forth herein.

### BACKGROUND OF THE INVENTION

1. Field of Invention

The present invention relates to a light guide plate positioning structure, and more particularly to a light guide plate positioning structure combining location guiding with an anti-collision design.

2. Related Art

In the prior art, a liquid crystal display (LCD) device includes two main components: a panel module and a backlight module. The backlight module includes an optical film assembly, a light guide plate, a reflective sheet, an inside frame, an outside frame and a light emitting module. The optical film assembly, the light guide plate and the reflective sheet are disposed in the inside frame in sequence.

FIG. 1A is a schematic view of a light guide plate positioning structure in the prior art, and FIG. 1B is a schematic partially enlarged view of Part a in FIG. 1. For the purpose of limiting and positioning displacement of the light guide plate 2, both sides of the light guide plate 2 are processed to form more than one concave notches 21 respectively, and both inner sides of the inside frame 1 are also processed to form more than one ear portions 11. The ear portion 11 and the concave notch 21 correspond to each other in terms of positions, and the ear portion 11 is clamped in the concave notch 21, so that the light guide plate 2 is positioned in the inside frame 1 and the displacement of the light guide plate 2 is limited.

However, first, in this design, a cutting process needs to be performed on the light guide plate, and a molding process needs to be performed on the frame, thereby increasing fabrication cost of a liquid crystal panel. Second, when being attached to the light guide plate, the reflective sheet must be attached to a side edge of the light guide plate section by section to correspond to a shape and size of an opening of the concave notch, thereby increasing the assembly time and assembly cost of the whole liquid crystal panel. Third, shapes of the concave notch and the ear portion need to be as tight as possible. If the shape of the ear portion is designed too small or the shape of the concave notch is designed too large, the light guide plate is displaced due to too big movement space and may collide with the light emitting module when being displaced, so that a light emitting direction of the light emitting module deviates, or components of the light emitting module are damaged due to the collision, so a fabrication yield of the liquid crystal panel is decreased, and furthermore, a damage rate of the fabricated LCD device is high.

Therefore, the problem that is considered by a manufacturer is how to design a light guide plate fixing structure to position the light guide plate, and at the same time reduce the assembly time and fabrication cost and prevent the light guide plate from colliding with and damaging other components.

### SUMMARY OF THE INVENTION

The present invention is directed to a liquid crystal panel having a positioning structure for guiding a light guide plate to be positioned and limiting displacement of the light guide plate.

In order to solve the structural problem, the present invention provides a light guide plate positioning structure of a liquid crystal panel, in which the liquid crystal panel comprises a frame for a light guide plate to be placed in. A light emitting module adjacent to the light guide plate is disposed on the frame, and has a plurality of light emitting units arranged with gaps. The light guide plate positioning structure comprises a plurality of first positioning blocks, a plurality of positioning portions and a plurality of second positioning blocks. The first positioning blocks are disposed on the frame, and locations of the first positioning blocks are opposite to corners of the light guide plate. The positioning portions are formed on the light guide plate, forming locations of the positioning portions are corners adjacent to the first positioning blocks, and each positioning portion and each first positioning block are held together. The second positioning blocks are disposed on the frame, located in the gaps between the light emitting units, and used to resist a side edge of the light guide plate, so that the a space is formed between the light emitting unit and the light guide plate.

The characteristics of the present invention are as follows. First, through cooperation of the first positioning block and the positioning portion of the present invention, the light guide plate can be accordingly positioned at a certain location of the frame, thereby reducing the assembly time. Second, the first positioning block and the positioning portion are held together, thereby effectively limiting the displacement of the light guide plate. Third, the positioning portions are formed at the corners of the light guide plate rather than side portions, so a reflective sheet is integrally attached on the side edge of the light guide plate and does not need to be attached section by section, thereby reducing the assembly time and increasing working efficiency. Fourth, the light guide plate only needs to be processed at the corners to form the positioning portions, so the process is simple and rapid, and the cost may also be reduced. Fifth, the positioning blocks may be fixed or directly formed on the frame; if the positioning blocks are directly formed on the frame, only some minor modifications need to be performed on a mould, and additional members do not need to be added. Sixth, the second positioning block and the light guide plate are directly held together, so as to prevent the light guide plate from being displaced and directly colliding with the light emitting units.

### BRIEF DESCRIPTION OF THE DRAWINGS

The present invention will become more fully understood from the detailed description given herein below for illustration only, and thus are not limitative of the present invention, and wherein:

FIG. 1A is a schematic view of a light guide plate positioning structure in the prior art;

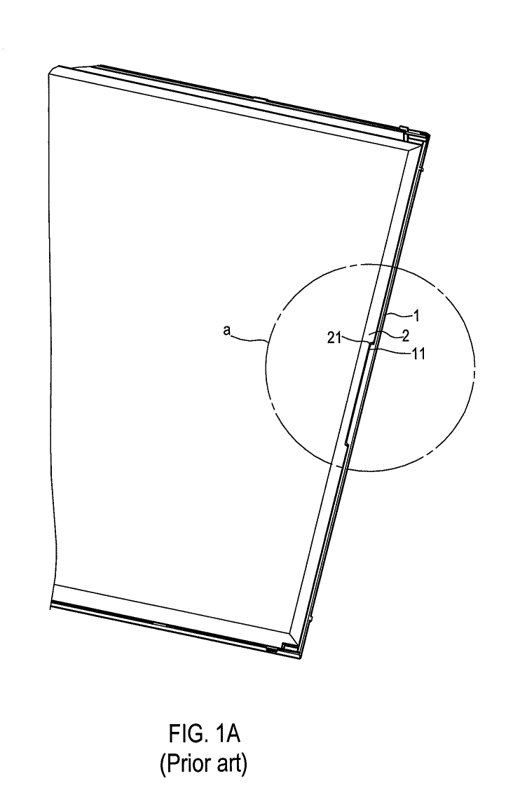

FIG. 1B is a schematic partially enlarged view of Part a in FIG. 1A;

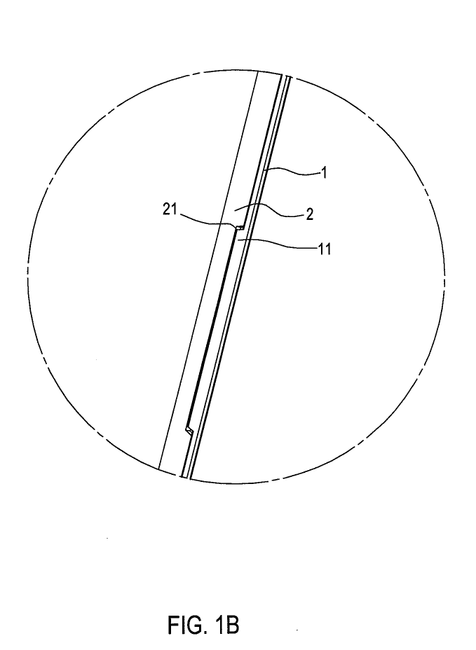

FIG. 2A is a schematic view of a light guide plate positioning structure of a liquid crystal panel according to a first embodiment of the present invention;

FIG. 2B is a schematic view of a first structure of a positioning portion according to the present invention;

FIG. 3A is a schematic view of a light guide plate positioning structure of a liquid crystal panel according to a second embodiment of the present invention;

FIG. 3B is a schematic view of a second structure of a positioning portion according to the present invention;

FIG. 4A is a schematic view of a light guide plate positioning structure of a liquid crystal panel according to a third embodiment of the present invention; and

FIG. 4B is a schematic view of a third structure of a positioning portion according to the present invention.

### DETAILED DESCRIPTION OF THE INVENTION

Preferred embodiments of the present invention are described below with reference to the accompanying drawings.

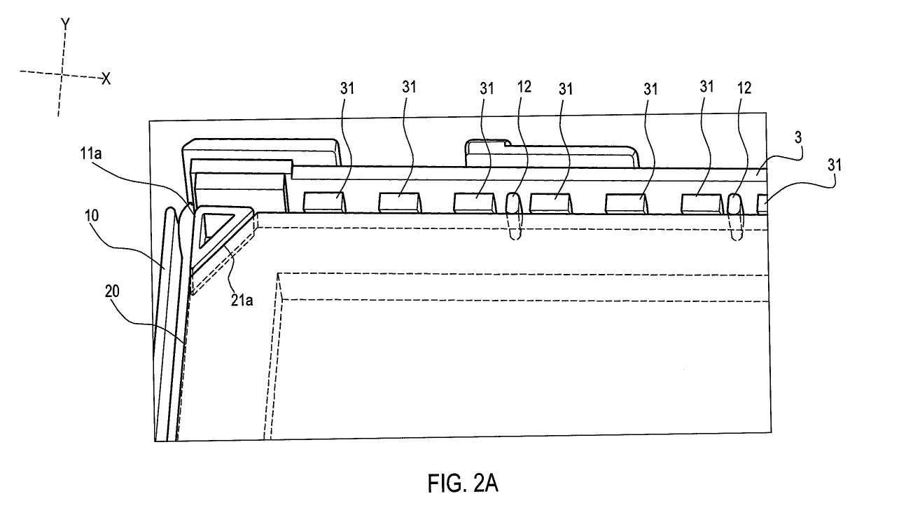

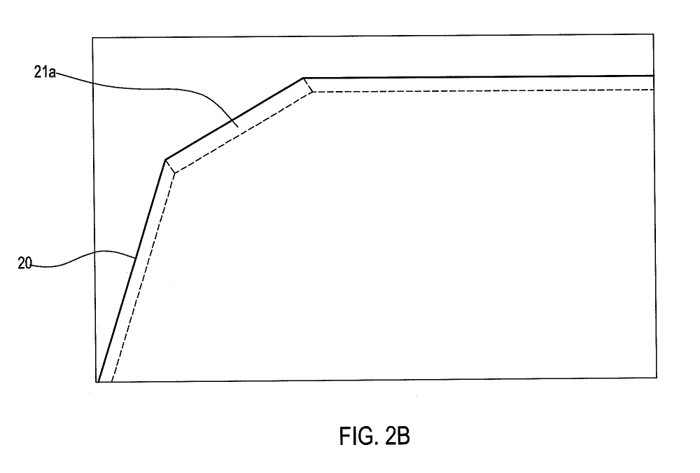

FIG. 2A is a schematic view of a light guide plate positioning structure of a liquid crystal panel according to a first embodiment of the present invention, and FIG. 2B is a schematic view of a first structure of a positioning portion according to the present invention. In the following embodiments, a partial structure of the liquid crystal panel is displayed to clearly present features of the light guide plate positioning structure. The liquid crystal panel includes a backlight module having a frame 10, on which a light guide plate 20 and a light emitting module 3 are placed. A disposition location of the light emitting module 3 is adjacent to a placement location of the light guide plate 20, and the light emitting module 3 has a plurality of light emitting units 31 arranged with gaps. A light emitting diode (LED) light bar is taken as an example for the light emitting module 3 in the following, and the light emitting units 31 are a plurality of LEDs on an LED light bar, so as to form a plurality of point light sources disposed and arranged with gaps.

The light guide plate positioning structure is disposed on the frame 10 and the light guide plate 20 and used for fixing and locating the light guide plate 20 on the frame 10. The light guide plate positioning structure includes a plurality of first positioning blocks 11a, a plurality of second positioning blocks 12 and positioning portions 21a. Each first positioning block 11a is disposed (or formed) on the frame 10, and a disposition location of each first positioning block 11a is opposite to a corner of the light guide plate 20. As viewed from FIG. 2A, the disposition location of the first positioning block 11a is also quite close to a corner of the frame 10.

The positioning portion 21a is formed at the corner of the light guide plate 20 and is adjacent to the disposition location of the first positioning block 11a. A shape of the positioning portion 21a and an external shape of the first positioning block 11a correspond to each other, so that the shape of the positioning portion 21a fits the shape of the first positioning block 11a or the positioning portion 21a and the first positioning block 11a are held together, thereby limiting displacement of the light guide plate 20. However, designs of the shapes of the first positioning block and the positioning portion are not limited and are determined according to designers.

In this embodiment, the first positioning block 11a is designed as a triangular cylinder having a bevel edge facing the corner of the light guide plate 20. The positioning portion 21a includes a lead angle having a shape corresponding to the bevel edge. When the light guide plate 20 is placed on the frame 10, the lead angle and the bevel edge at corresponding locations fit tightly with each other. As shown in FIG. 2A, after the bevel edge of the first positioning block 11a and the lead angle tightly fit, displacements of the light guide plate in an X direction and a Y direction are limited.

In order to further limit the displacement of the light guide plate 20, when being disposed on the frame 10, the first positioning block 11a may be disposed at locations corresponding to two corners of the light guide plate 20, and the positioning portions 21a is also formed at the two corners to fit the first positioning blocks 11a. The two corners are formed in a diagonal direction. Alternatively, furthermore, the positioning portions 21 a may be disposed at four corners of the light guide plate 20 and all form the lead angles, and the first positioning blocks 11a are disposed on the frame 10 and locations of the first positioning blocks 11 a correspond to the four corners of the light guide plate 20.

The second positioning blocks 12 are also disposed on the frame 10, located between gaps between the light emitting units 31, and mainly used for resisting a side edge of the light guide plate 20 to prevent the light guide plate 20 from colliding with the light emitting units 31 under the effect of an external force. Meanwhile, when the second positioning blocks 12 resists the side edge of the light guide plate 20, a friction force is generated between the second positioning blocks 12 and the light guide plate 20, so as to limit a sliding amount of the light guide plate 20 in the Y direction. However, at least two manners for disposing the second positioning blocks 12 exist: disposing the second positioning blocks 12 at the gaps between the light emitting units 31 in a continuous and uninterrupted manner, and disposing the second positioning blocks 12 at the gaps between the light emitting units 31 without a specific sequence in a non-continuous and interrupted manner. The manner for disposing the second positioning blocks 12 is not limited, and similar disposing manner is also applicable, and the disposing manner is determined according to requirements of the designer.

The first positioning blocks 11a and the second positioning blocks 12 may be directly formed on the frame 10, or fixed on the frame 10 after being made of a soft or elastic material. The material may be rubber, elastic plastics or soft plastics. When the first positioning blocks 11a and the second positioning blocks 12 are directly formed on the frame 10, only some minor modifications are performed on a mould.

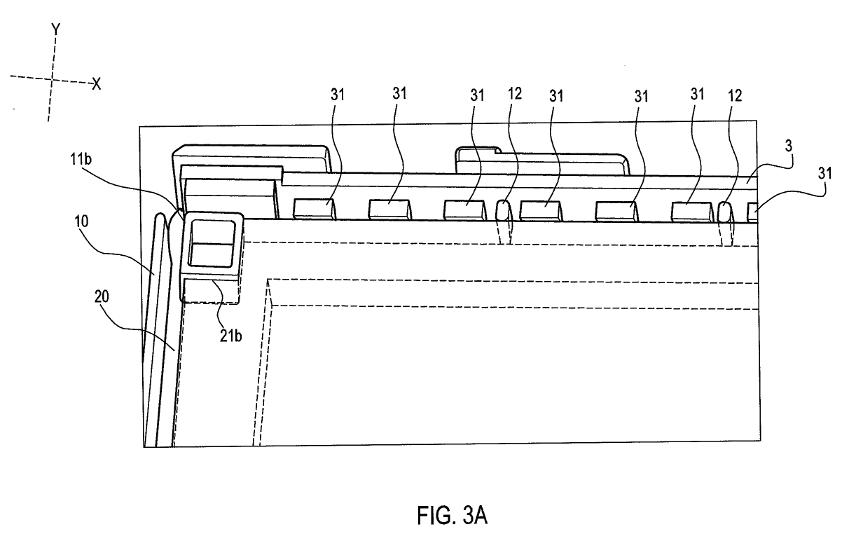

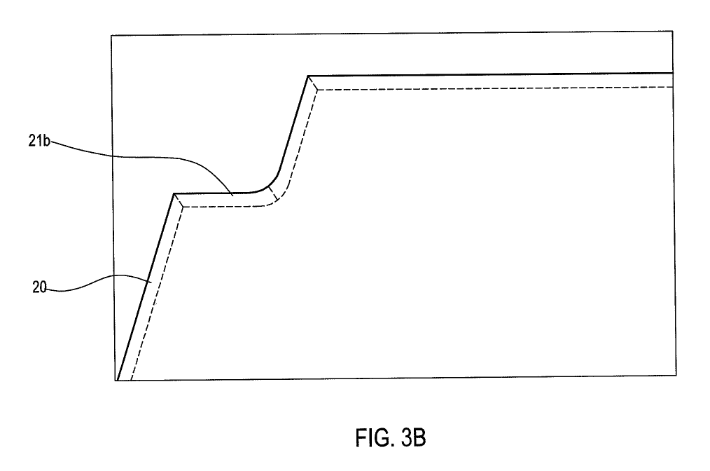

FIG. 3A is a schematic view of a light guide plate positioning structure of a liquid crystal panel according to a second embodiment of the present invention, and FIG. 3B is a schematic view of a second structure of a positioning portion according to the present invention. In the second embodiment, structures of first positioning blocks and positioning portions are different from those in the first embodiment. In this embodiment, the first positioning block 11b is a rectangular column having an angle position towards the light guide plate 20. The positioning portion 21b includes a concave edge. A shape of the concave edge matches the angle position, but the concave edge and the angle position do not necessarily fit tightly, and only need to be held together, so as to achieve the purpose of limiting the displacement of the light guide plate 20.

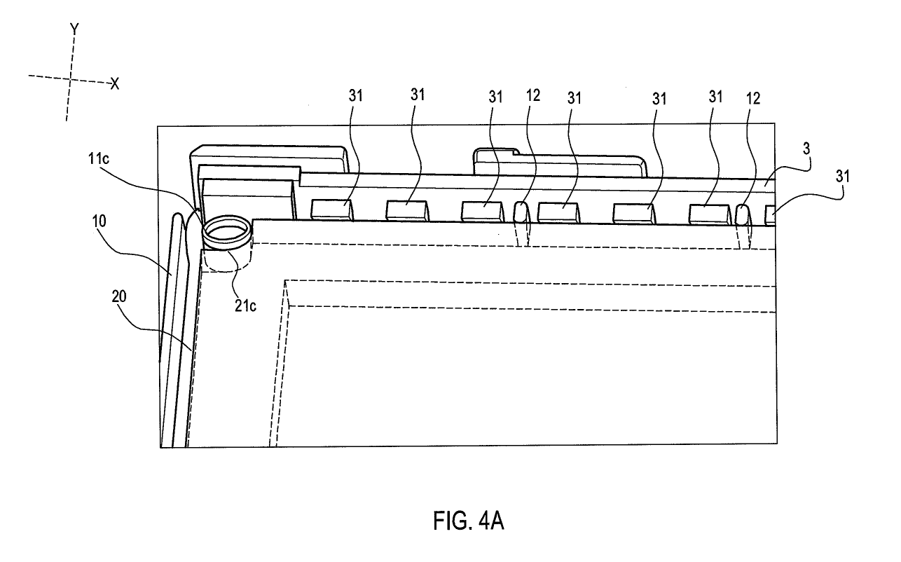

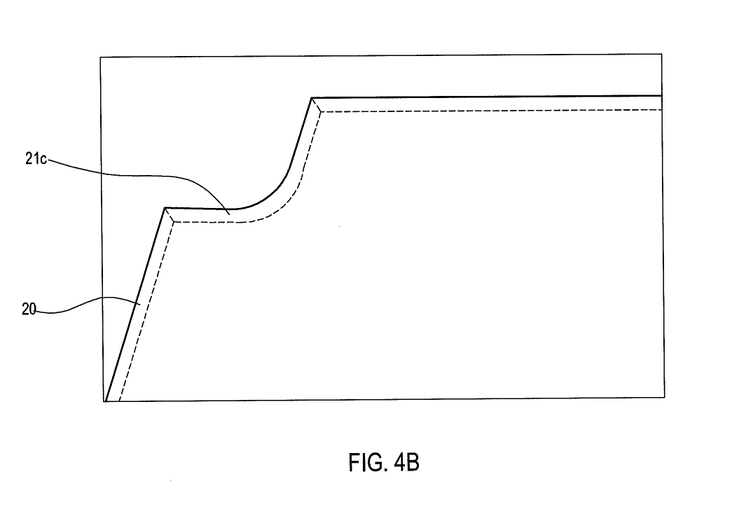

FIG. 4A is a schematic view of a light guide plate positioning structure of a liquid crystal panel according to a third embodiment of the present invention, and FIG. 4B is a schematic view of a third structure of a positioning portion according to the present invention. In the second embodiment, structures of first positioning blocks and positioning portions are different from those in the first and second embodiments. In this embodiment, the first positioning block 11c is a circular column. The positioning portion 21c includes a slightly arc-shaped concave edge. The concave edge is used for resisting a side edge of the circular column so the concave edge and the circular column are held together, so as to achieve the purpose of limiting the displacement of the light guide plate 20.

In conclusion, the present invention is only described as implementation or embodiments presenting the technological means adopted to solve the problems. The description is not intended to limit the scope of the present invention patent. Any equivalent variations and modifications conforming to the meaning of the claims of the present invention patent or made according to the scope of the present invention patent are intended to be included within the scope of the present invention patent.

What is claimed is:

1. A light guide plate positioning structure of a liquid crystal panel, wherein the liquid crystal panel comprises a frame for a light guide plate to be placed in, a light emitting module adjacent to the light guide plate is disposed on the frame, and has a plurality of light emitting units arranged with gaps, and the light guide plate positioning structure comprises:
a plurality of first positioning blocks, wherein each first positioning block is disposed on the frame, and a location of each first positioning block corresponds to a corner of the light guide plate;
a plurality of positioning portions, formed at corners of the light guide plate adjacent to the first positioning blocks and used to be held against the first positioning blocks; and
a plurality of second positioning blocks, disposed on the frame, located between the gaps between the light emitting units, and used to resist a side edge of the light guide plate, so that the a space is formed between the light emitting units and the light guide plate.

2. The light guide plate positioning structure according to claim 1, wherein each first positioning block is a triangular cylinder having a bevel edge facing the light guide plate, each positioning portion comprises a lead angle, and the lead angles and the bevel edges fit tightly with each other.

3. The light guide plate positioning structure according to claim 1, wherein each first positioning block is a rectangular column having an angle position facing the light guide plate, each positioning portion comprises a concave edge, and the concave edges and the wedge-shaped positions are held together.

4. The light guide plate positioning structure according to claim 1, wherein each first positioning block is a circular column, each positioning portion comprises a concave edge, and the concave edges are used to resist a side edge of the circular column.

5. The light guide plate positioning structure according to claim 1, wherein the first positioning blocks are disposed on the frame, disposition locations of the first positioning blocks correspond to two corners of the light guide plate, and the corners are formed in a diagonal direction.

6. The light guide plate positioning structure according to claim 1, wherein the first positioning blocks are disposed on the frame, and disposition locations correspond to four corners of the light guide plate.

7. The light guide plate positioning structure according to claim 1, wherein the second positioning blocks are disposed at the gaps between the light emitting units in a continuous and uninterrupted manner.

8. The light guide plate positioning structure according to claim 1, wherein the second positioning blocks are disposed at the gaps between the light emitting units in an interrupted manner.

9. The light guide plate positioning structure according to claim 1, wherein the first positioning blocks and the second positioning blocks are directly formed on the frame.

10. The light guide plate positioning structure according to claim 1, wherein the first positioning blocks and the second positioning blocks are made of an elastic material and are fixed on the frame, and the elastic material is rubber or elastic plastics.
